(19) United States
(12) Patent Application Publication
(10) Pub. No.: US 2016/0032426 A1
(43) Pub. Date: Feb. 4, 2016

(54) OPTIMIZED NICKEL ALLOY AND TURBINE BLADE MADE THEREOF

(71) Applicant: SIEMENS AKTIENGESELLCHAFT, München (DE)

(72) Inventors: Magnus Hasselqvist, Finspong (SE); Fredrik Karlsson, Aby (SE)

(21) Appl. No.: 14/777,103

(22) PCT Filed: Jan. 22, 2014
(86) PCT No.: PCT/EP2014/051174

§ 371 Date: Sep. 15, 2015

(30) Foreign Application Priority Data
Mar. 21, 2013 (EP) 13160357.3

(51) Int. Cl. C22C 19/05; F01D 5/28

(52) U.S. Cl. CPC C22C 19/058; F01D 5/28; F05D 2300/177

(57) ABSTRACT

A nickel alloy includes a proportion by weight of Cr of 12.3% to 13.7%, a proportion by weight of Al of 4.3% to 4.7% and a proportion by weight of Co of 4% to 6%. The components are preferably Cr, Mo, Re and/or W, Al, Ti, Ta, Hf, Si, reactive elements including actinides and lanthanides, C, optionally the components Zr and/or B. The proportions by weight are selected such that both a desired high creep resistance and also a desired high hot corrosion resistance are achieved. A turbine blade is made of the nickel alloy.

### CROSS REFERENCE TO RELATED APPLICATIONS

This application is the US National Stage of International Application No. PCT/EP2014/051174 filed 22 Jan. 2014, and claims the benefit thereof. The International Application claims the benefit of European Application No. EP13160357 filed 21 Mar. 2013. All of the applications are incorporated by reference herein in their entirety.

### FIELD OF INVENTION

The invention relates to an optimized nickel alloy, especially for use in turbine blades.

### BACKGROUND OF INVENTION

Nickel alloys in turbine blades should withstand maximum temperatures, since a relatively high temperature permits a higher efficiency of the thermal power plant in which the turbine blades are to be used. The permissible temperature is limited because the creep resistance and/or hot corrosion resistance of the alloy decrease at excessively high temperatures. The problem here is that hot corrosion resistance distinctly decreases at a chromium content—where contents are referred to in the course of this discussion, what are always meant are proportions by weight—of below 12%. Creep resistance, in contrast, falls with rising chromium content. In order to achieve a reasonable compromise, therefore, alloys having a chromium content of 12% or just above have therefore been used to date.

JP 2000 063969A discloses a nickel alloy having a cobalt content of 10% to 14%, a chromium content of 10% to 13%, a molybdenum content of 0.1% to 3%, a tungsten content of 4% to 8%, an aluminum content of 4% to 6%, a titanium content of 1% to 4%, a tantalum content of 4% to 8%, a hafnium content of 0.1% to 0.5% and a rhenium content of not more than 2%. The remainder is nickel with unavoidable impurities. This alloy exhibits high creep resistance and high-temperature stability and is thus suitable for gas turbine parts.

JP H10 204594 A is concerned with the production of large turbine housings or turbine blades. Here too, a high high-temperature stability and creep resistance are required.

For this purpose, a nickel alloy having the following composition is proposed: chromium content 12.0% to 14.3%, cobalt content 8.5% to 11.0%, molybdenum content 1.0% to 3.5%, tungsten content 3.5% to 6.2%, tantalum content 3.0% to 5.5%, aluminum content 3.5% to 4.5%, titanium content 2.0% to 3.2%, carbon content 0.04% to 0.12% and boron content 0.005% to 0.5%. The remainder is nickel with unavoidable impurities.

EP 0 040 102 A1 discloses a nickel-based alloy. The alloy has a carbon content of 0% to 0.2%, a chromium content of 11.5% to 12.2%, a cobalt content of 4% to 8%, a content of molybdenum and tungsten of 4.5% to 5.2%, where the ratio of molybdenum to tungsten is 1.2 to 1.8, a proportion of aluminum and titanium of 8.8% to 9.7%, where the ratio of aluminum to titanium is 0.8 to 1.1, a boron content of 0% to 0.4%, and a zirconium content of 0% to 0.1%.

CN 101 857 931 A discloses a high-strength corrosion-resistant nickel alloy. The chromium content here is 11.0% to 15.0%, the cobalt content 8.0% to 9.0%, the molybdenum content 1.8% to 2.2%, the tungsten content 3.5% to 4.4%, the tantalum content 5.0% to 6.0%, the aluminum content 4.0% to 5.4%, the titanium content 2.5% to 3.5%, the boron content 0.004% to 0.007%, and the carbon content 0.01% to 0.03%.

### SUMMARY OF INVENTION

A problem addressed by the invention is that of providing an even more suitable material for turbine blades, which enables higher operating temperatures and hence higher efficiencies.

A solution to this problem can be found particularly in the independent claim. The dependent claims indicate advantageous further developments. Further details can be found in the description and the figures.

It has been recognized that a nickel alloy having a proportion by weight of chromium (Cr) of 12.3% to 12.7%, a proportion by weight of aluminum (Al) of 4.3% to 4.7% and a proportion by weight of cobalt (Co) of 4% to 6% should be used. For the sake of completeness, it should be mentioned that the nickel alloy, aside from the components mentioned and components mentioned later, and in some cases additional unmentioned components, contains mainly nickel, such that the sum total of all the proportions by weight is 100%. In this context, any impurities should be taken into account. While the contents mentioned for chromium are known in the prior art, for instance in the frequently used alloys IN792, PWA1483 or IN792DS, different proportions by weight of aluminum have always been used. It has been found that it is important to choose this proportion by weight of aluminum in order to obtain satisfactory hot corrosion resistance together with a desirable creep resistance. In fact, both the creep resistance and the hot corrosion resistance amount to a stability at temperatures in the range from 800° C. to 900° C., as can occur in the operation of gas turbines. Such temperatures can also occur in other applications, for instance in aircraft engines. Coming back to gas turbines, it should be stated that, in the case of two-stage gas turbines, a rise by 30° C. in the permissible temperature of the turbine blades enables an increase in the firing temperature by 50° C. Overall, the performance can thus be increased by 10 percentage points. The efficiency, which is becoming ever more important in view of energy supply difficulties, can be increased by 1 percentage point. With regard to the efficiencies of gas turbines, which are already very high, this is another notable rise.

Over wide areas, there are no exact explanations as to why particular proportions by weight of various components or ranges of proportions by weight of these components are advantageous for the desired properties. The reasons are frequently not even known exactly. This is ultimately irrelevant; for an executable technical teaching, it is sufficient to specify the proportions by weight or ranges of proportions by weight. It will be appreciated that all numerical values are subject to certain uncertainties and must not be regarded as an absolutely strict limit.

In fact, the numerical values give a guide and enable illustration of the differences from known alloys.

Particularly good results can be achieved when the proportion by weight of chromium is 12.5%.

A further important criterion has been found to be the proportion by weight of tantalum (Ta) to titanium (Ti). A favorable range for alloys having high creep resistance and high hot corrosion resistance here is the range from 2 to 3.5.

In an advantageous embodiment, the proportion by weight of aluminum is 4.4% to 4.6%. This has been found to be advantageous particularly in the case of particular monocrystalline alloys.

In a further embodiment, the proportion by weight of aluminum is 4.3% to 4.5%. This is likewise advantageous for particular monocrystalline alloys. However, this proportion by weight has also been found to be advantageous for an embodiment in which it is ensured that the solidification that follows the casting of the components is what is called a directed solidification, which leads to high stability.

For a further embodiment, or more specifically for a multitude of further embodiments, of the nickel alloy, it has been found that the following components should be present: nickel, cobalt, chromium, molybdenum (Mo), rhenium (Re) and/or tungsten (W), aluminum, titanium, tantalum, hafnium (Hf), silicon (Si), a particular amount of reactive elements including actinides and lanthanides and the like, and carbon (C). Finally, there may additionally be zirconium (Zr) and boron (B) if required. The proportions by weight should be chosen so as to achieve a desirable high hot corrosion resistance together with a desirable high-temperature creep resistance.

With regard to the elements rhenium and tungsten, it should be stated that embodiments in which both rhenium and tungsten occur, but also embodiments in which either rhenium or tungsten occurs, shall be encompassed in the context of this paragraph and of the corresponding claim. In general, apart from minor impurities, no further components apart from the aforementioned components are present.

For a number of embodiments, the proportion by weight of zirconium shall be 0% to 0.1% and the proportion by weight of boron 0% to 0.02%. Thus, also encompassed are embodiments in which neither boron nor zirconium is present. These weight ranges have been found to be advantageous for a multitude of alloys.

In one embodiment of the invention, the proportion by weight of tungsten here is 3.3% to 3.7%. In addition, the proportion by weight of zirconium may be 0.01% to 0.1%. In addition, a proportion by weight of boron of 0.005% to 0.2% may be provided. These values have been found to be advantageous for an embodiment in which the aim is directed solidification of the cast nickel alloy. In this embodiment, there is generally no rhenium present.

In a further embodiment of the invention, the proportion by weight of zirconium is 0.02% and the proportion by weight of tungsten 3.3% to 3.7%. Normally, there is likewise no rhenium added here. The aforementioned composition has been found to be advantageous for a monocrystalline embodiment.

In a further embodiment, the proportion by weight of zirconium is 0.05% and/or the proportion by weight of boron is 0.005%. These proportions by weight have been found to be useful for an embodiment in which the alloy is to be in monocrystalline form.

In a further embodiment, the proportion by weight of zirconium is 0.02% and/or the proportion by weight of each of W and Re is 1.8% to 2.2%. Normally, no additional boron is provided here. These values have been found to be useful for a further nickel alloy which is to be in monocrystalline form.

As already addressed, the nickel alloy outlined above is suitable for manufacturing a turbine blade therefrom. In this case, it is optionally possible for further components not manufactured from the nickel alloy outlined to be present in the turbine blade.

In one embodiment, the turbine blade is a monocrystalline casting made from the nickel alloy outlined. In fact, advantage is given for this purpose to choosing those embodiments of the nickel alloy that are suitable for the purpose as described. The turbine blade may, as well as the monocrystalline casting, also include further components.

In a further embodiment, the turbine blade is a casting made from the nickel alloy outlined by directed solidification. In fact, advantage is given for this purpose to choosing those embodiments of the nickel alloy that are suitable for the purpose as described. The turbine blade may, as well as the casting made by directed solidification, also include further components.

### BRIEF DESCRIPTION OF THE DRAWINGS

Further details of the invention are to be described in detail hereinafter with reference to figures and tables. The figures show:

FIG. 1: the chromium content and the aluminum content of known alloys and of the inventive alloy

FIG. 2: the aluminum content and the ratio of tantalum to titanium in known alloys and the inventive alloy

FIG. 3: a table containing the ranges of values for the variety of different embodiments of the invention.

### DETAILED DESCRIPTION OF INVENTION

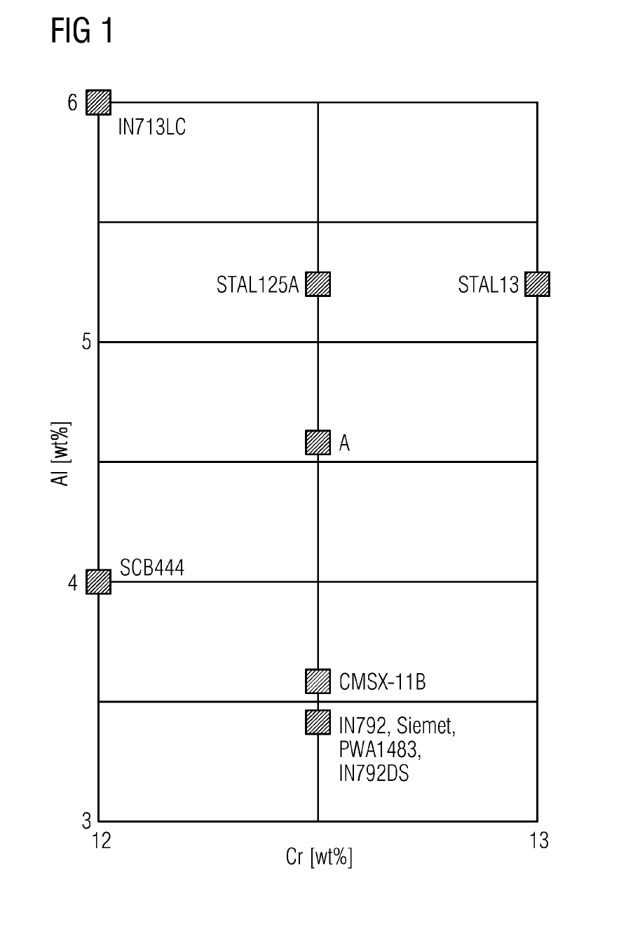

In FIG. 1, the proportion by weight of chromium is plotted on the abscissa. The starting value on the left is a proportion by weight of 12%. The maximum proportion by weight of chromium is attained on the right at a proportion by weight of 13%. The proportion by weight of aluminum is shown on the ordinate, beginning at 3% and ending at 6%. The individual boxes mark predominantly known alloys. For instance, right at the bottom on the line with a proportion by weight of chromium of 12.5%, it is shown that the alloys IN792, Siemet, and also PWA1483 and IN792DS are to be found there. These are known, proven alloys. The aluminum content thereof is just below 3.5%. The same proportion by weight of chromium, i.e. 12.5%, but a somewhat higher proportion by weight of aluminum of just over 3.5% is possessed by the alloy CMSX-11B. The alloy SCB444 is to be found at a proportion by weight of aluminum of 4% and a proportion by weight of chromium of 12%. Further up, there is then an identified region with one box labeled A. In this region which has not been occupied by nickel alloys to date, i.e. a proportion by weight of chromium of 12% to 13% and a proportion by weight of aluminum of 4.3% to 4.7%, nickel alloys having a high hot corrosion resistance and likewise a high high-temperature compressive strength are encountered. The point A indicates a particularly advantageous embodiment. Above the identified region there is again a number of known alloys, such as STAL125 with a chromium content of 12.5% and an aluminum content of 5.2%. STAL13 is to be found at this aluminum content and a chromium content of 13%. Finally, IN713LC is marked, which has an aluminum content of 6% and a chromium content of 12%.

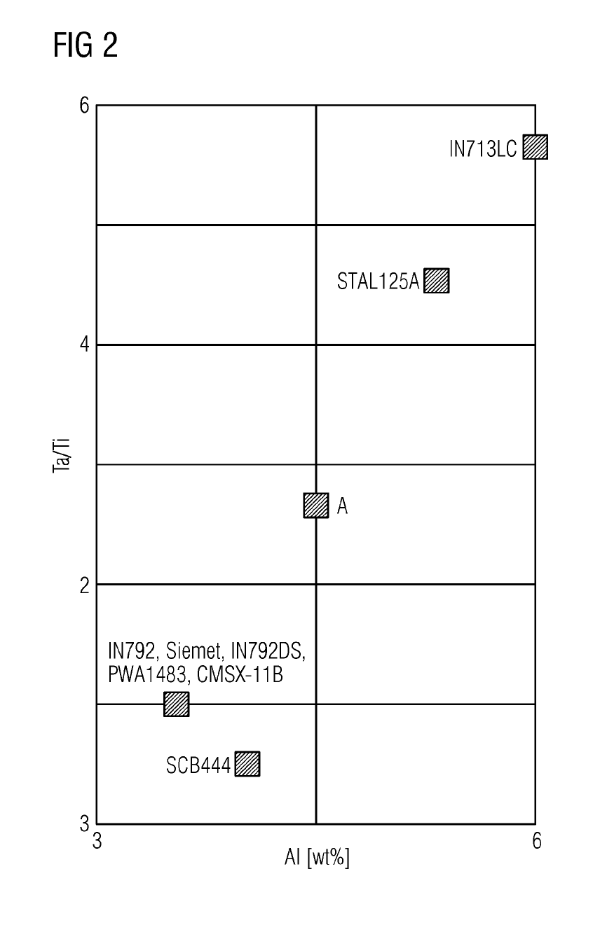

Further information is given by FIG. 2. Plotted on the abscissa is the proportion by weight of aluminum, which begins at 3% and ends at 6%. Plotted on the ordinate is the ratio of tantalum to titanium, which has been recognized as being important, beginning at 0 and ending at 6. In the lower region are the alloys SCB444 also shown in FIG. 1, and further up the alloys IN792, Siemet, IN792DS, PWA1483 and CMSX-11B. In the identified region above are the alloys of the invention. The box A again shows a particularly advantageous embodiment. Further up are the alloys STAL125A likewise known from the prior art, and finally the alloy IN713LC. From this too, it becomes clear that there are no alloys to date in the range of values of the alloy of the invention. The parameters shown here, i.e. the proportion by weight of aluminum and the weight ratio of tantalum to titanium, are parameters which have been recognized as important.

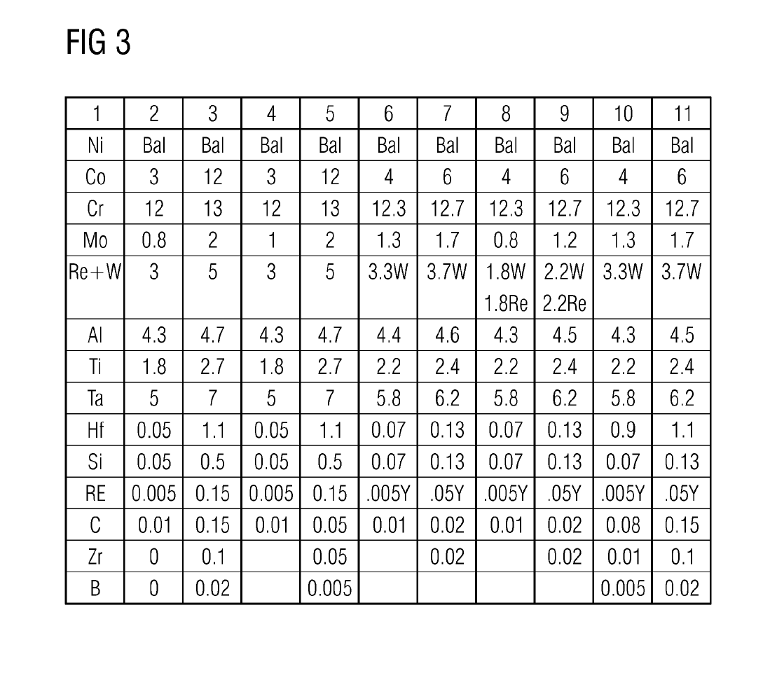

FIG. 3, finally, shows a table in which ranges of values of important embodiments of the invention are given. In the whole left-hand column, from the top downward, the elements are listed. First the main component nickel. Then, in order, the elements cobalt, chromium, molybdenum, then the sum total of rhenium and tungsten, and additionally aluminum, titanium, tantalum, hafnium and silicon. There then follow reactive elements, abbreviated to RE. This is understood to mean the sum total of actinides and lanthanides and similar elements. These are followed by carbon, zirconium and boron.

The second and third columns give the minimum and maximum proportions by weight in each case. Findings to date indicate that all possible embodiments of the invention fall within this range of values. However, this shall not rule out the invention leaving outside these values too or through addition of further components.

It should be explained that the value reported for the main nickel component is always Bal. This is supposed to express the fact that mainly nickel is present aside from the other components. In fact, there is always so much nickel present that the sum total of all the proportions by weight is 100%.

To the right there then follow further pairs of columns. In the left-hand column of a pair of columns is again the minimum value and to the right again the maximum value for the particular embodiments. Columns 4 and 5, and 6 and 7, and 8 and 9 are monocrystalline embodiments. The last two columns, columns 10 and 11, are a range for an embodiment in which the nickel alloy is in the form of an alloy solidified by directed solidification.

It should be emphasized that the values mentioned could not be predicted as correct values from the outset. As already explained, there is no need to give a scientifically watertight explanation for the values. However, there is no intention to deny that the analysis of known alloys, their properties and their composition gives certain clues as to how the alloy should look.

Even though the invention has been illustrated in detail and described by the working example, the invention is not restricted by the examples disclosed, and other variations can be derived therefrom by the person skilled in the art without leaving the scope of protection of the invention.

1.-14. (canceled)

15. A nickel alloy having
a proportion by weight of Cr of 12.3% to 12.7%,
a proportion by weight of Al of 4.3% to 4.7% and
a proportion by weight of Co of 4% to 6%,
optionally Mo,
optionally Re and/or W,
optionally Ti,
optionally Ta,
optionally Hf,
optionally Si,
optionally reactive elements consisting of actinides and lanthanides,
optionally C,
optionally Zr and/or B,
the balance being Ni and impurities.

16. The nickel alloy as claimed in claim 15,
wherein the proportion by weight of Cr is 12.5%.

17. The nickel alloy as claimed in claim 15,
wherein the weight ratio of Ta to Ti is 2 to 3.5.

18. The nickel alloy as claimed in claim 15,
wherein the proportion by weight of Al is 4.4% to 4.6%.

19. The nickel alloy as claimed in claim 15,
wherein the proportion by weight of Al is 4.3% to 4.5%.

20. The nickel alloy as claimed in claim 15,
wherein the proportion by weight of Zr is 0% to 0.1% and/or
the proportion by weight of B is 0% to 0.02%.

21. The nickel alloy as claimed in claim 15,
wherein the proportion by weight of W is 3.3% to 3.7% and/or
the proportion by weight of Zr is 0.01% to 0.1% and/or
the proportion by weight of B is 0.005% to 0.2%.

22. The nickel alloy as claimed in claim 15,
wherein the proportion by weight of Zr is 0.02% and/or
the proportion by weight of W is 3.3% to 3.7%.

23. The nickel alloy as claimed in claim 22,
wherein the proportion of B is 0%.

24. The nickel alloy as claimed in claim 15,
wherein the proportion by weight of Zr is 0.05% and/or
the proportion by weight of B is 0.005%.

25. The nickel alloy as claimed in claim 15,
wherein the proportion by weight of Zr is 0.02%, and/or
the proportion by weight of each of W and Re is 1.8% to 2.2%.

26. The nickel alloy as claimed in claim 25,
wherein the proportion of B is 0%.

27. A turbine blade consisting of
a nickel alloy as claimed in claim 15.

28. The turbine blade as claimed in claim 27,
wherein the turbine blade comprises a monocrystalline casting.

29. The turbine blade as claimed in claim 27,
wherein the turbine blade comprises a casting solidified by directed solidification.

30. A turbine blade comprising
a nickel alloy as claimed in claim 15.
